(19) United States
(12) Patent Application Publication
(10) Pub. No.: US 2013/0138757 A1
(43) Pub. Date: May 30, 2013

(54) COMPONENT ADDITION/SUBSTITUTION METHOD IN A HOME AUTOMATION WIRELESS SYSTEM

(71) Applicant: Paolo Ferron, Oderzo (IT)

(72) Inventor: Paolo Ferron, Oderzo (IT)

(73) Assignee: NICE S.P.A., Oderzo (IT)

(21) Appl. No.: 13/814,147

(22) PCT Filed: Aug. 3, 2011
(86) PCT No.: PCT/IB2011/053448

§ 371 Date: Feb. 4, 2013

(30) Foreign Application Priority Data
Aug. 5, 2010 (IT) VR2010A000162

(51) Int. Cl. H04W 8/22

(52) U.S. Cl. CPC H04W 8/22
USPC 709/208

(57) ABSTRACT

It is described a substitution/addition method of components in a home automation wireless system (NT1), for example for sliding or hinged doors or garage doors, shutters, blinds, curtains or blinds in general. The system is equipped with a Master component (M1) and at least one Slave component (S1) that are configured as a network (NT1) using the Master/Slave technique and communicate according to a wireless communication protocol in which—the at least one Slave and/or Master component stores an identifier data that is used in the protocol as identifier of the Master component and/or of the network (NT1), and—the at least one Slave component transmits said identifier data to a component not belonging to the network so that the latter can receive and store it.

The invention relates to a method of substituting and/or adding components in a wireless system for home automation, for example for sliding or swing gates, to which we will refer here as as an example, doors or garage doors, shutters, blinds, curtains or blinds in general.

The systems to automate the movement of a gate are usually composed primarily of at least one electric motor to move the gate, a central control unit, plus safety components such as photocells and pressure sensitive edges, alarms (buzzers or flashers) and command and management interfaces for the user, such as keypads and/or displays.

The cable connection between these components is very popular and used in most cases but quite expensive to install, due to the laying of pipes, channels for the wiring, masonry, small excavations and restoration works.

Therefore automation systems have developed with components that communicate in a totally wireless way, usually by radio.

The connected components form a wireless transmission and reception network.

A known problem is to initialize/configure a network of this type, especially during the installation phase in which each component must receive the data that identifies the network it belongs to and send its own to be accepted as a member of it.

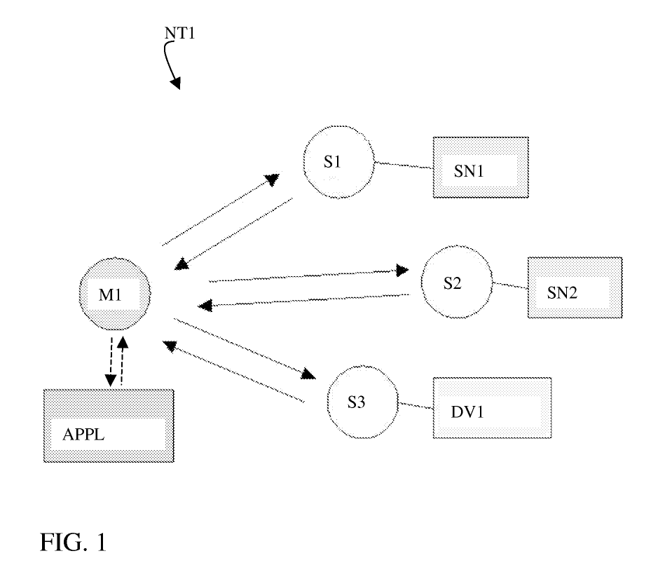

One of the possible configurations of the network is the star structure, with a Master node that forms the star center. See FIG. 1, which shows schematically a network NT1 that adopts the known transmission Master/Slave technique, with the center-star node that serves as Master node M1, and peripheral nodes that act as Slave nodes, indicated by S1, S2, etc. All nodes, whether Master or Slave, can be fully integrated into the component itself (central electronic units also integrated in the gearmotor, photocells, sensitive edges, flashing lights, card readers, etc.) or can be made into a separate body and then associated. The network NT1 envisages an electronic control unit as the Master node M1 and at least one photocell or similar as a Slave node S1, S2, etc.

As can be seen a Master M1 communicates with the Slaves S1, S2, which can act as interfaces to sensors SN1, SN2, etc. or other devices DV1, DV2, etc. The Master M1 also communicates with a block application APPL. For reasons of compatibility with existing plants, the Master node M1 can be connected to a central unit through the bus line, acting as an interface and making the pre-existing central unit believe (the application APPL) that the components are installed devices by wire connected to the bus. This solution enables the creation of hybrid automation systems with wired and/or wireless devices. It will be possible, by inserting the interface Master M1 into the bus, to add wireless items to already existing wired automation devices.

Each Slave has no cable connection with the exterior world, and is equipped with a battery power supply, preferably self-rechargeable by a photovoltaic module.

Both the Master M1 and the Slave S1, S2, etc. are each equipped with a microcontroller and a radio transmitter, not shown. The aim is to enable the Master and Slave to send and receive to/from each other coded radio signals and control data, indicated symbolically by the bi-directional arrows in FIG. 1. When in the following we will describe the operations performed by a Master or Slave by shortly attributing them directly to one of the two, we tacitly mean that the respective microcontroller executes program instructions and/or drives hardware means or devices adapted to perform the operation and/or the radio transmitter is controlled and/or the received signal is processed in order to perform these operations.

It is normal during the life of the network NT1 that the need arises to add a Slave node, or replace a Slave or Master.

Then the problem arises to make the operation simple, fast and with minimum intervention by the user.

A very critical case occurs when the node is a failed Master, and must be replaced. Normally the user or installer must reset each Slave, for example with a button on board, but this would take a long time to disassembly the Slaves and reset them. In fact, the reset button should not be easily accessible, for obvious safety reasons.

One must take into account that the Slave nodes once connected to the network respond only to the Master identified by a code and by the address of the network NT1 exchanged during the joining phase. The invention advantageously envisages that the identification code of the Master M1 and the address of the network NT1 coincide. With the procedure of prior art one should remove all the Slaves, act on the dip switches or jumpers or buttons, and then reconfigure the entire network from scratch. A long and tedious process that takes time, and inevitably is subject to error.

The main object of the invention is to propose a method of substitution/addition of a node belonging to a wireless home automation network that is fast and easy for a user.

A further object is to propose a method that does not require particular action by a user, but is fully automatic.

A further object is to propose a node component that implements the method.

These objects are achieved by a method and a component according to the attached claims.

We describe now a procedure in accordance to the invention of a wireless automation network, along with the attached drawing in which:

FIG. 1 shows a block diagram of a wireless automation system;

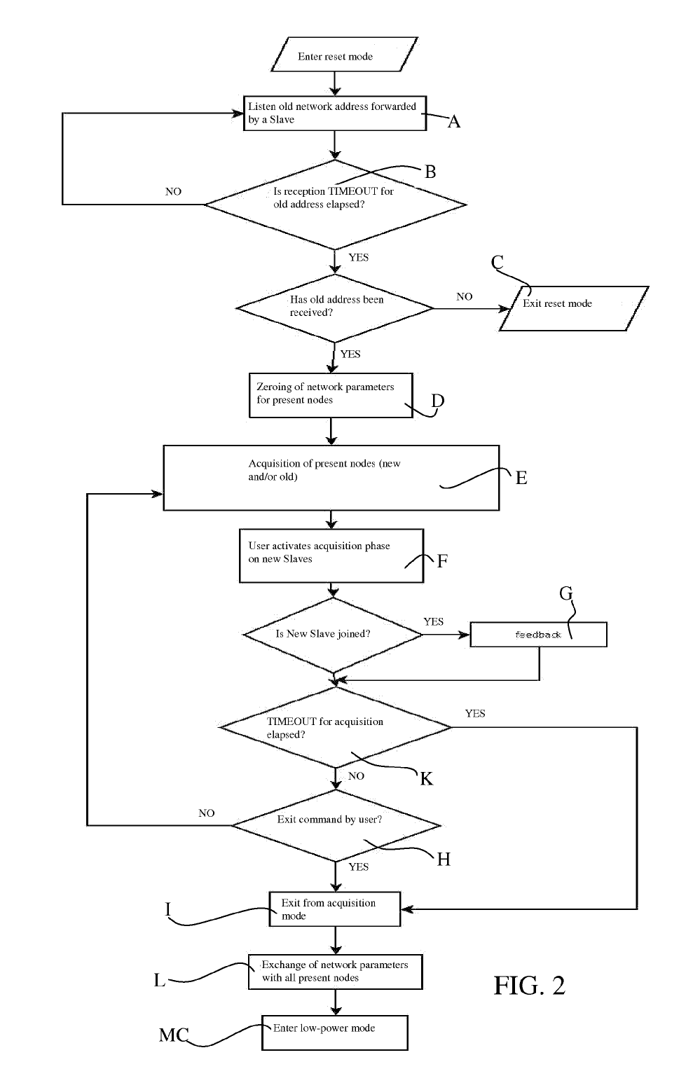

FIG. 2 shows a block diagram of a procedure for replacing a Master node of the network.

The invention proposes the following procedure.

With a system already installed and working, one can add one or more Slave as follows:
e.g. by pressing a button or by activation of analogous means by a user, the Master sets itself in acquisition mode of one or more new Slaves;
by inserting the battery into a new Slave, or, if it is already inserted, with the push of a button, the Slave is commanded to emit by radio a connection request and its own identification code, which will be received and stored by the Master. To acknowledge, the Master can signal the joined connection through warning means, e.g. a sound from a buzzer (or in general by warning means or alert means able to report the occurred association in the network and/or the condition of belonging to the network);
the Master will send a signal to the just connected Slave, to which the Slave for example can answer by warning means signaling the condition of belonging to the network NT1, e.g. by lighting LEDs. Then the procedure for the Slave is closed;
the acquisition procedure is terminated by pressing the button on the Master or after the expiration of a time-out.

At this point, the new device is installed and ready to work inside the network NT1. Repeating the procedure additional new Slaves can be installed at any time.

The invention also includes a procedure and means to cancel the connection of a Slave from a Master, therefore the expulsion of the Slave from the network NT1, so that it is possible to install it (reuse it) in a different network, new or existing (for example to replace a keyed selector with a numeric keypad). The procedure entails:
to switch off the power supply by disconnecting the battery of the Slave, or to press a reset button on the Slave (the Slave's internal memory is completely erased);
to command a new initialization/configuration procedure or connection to the Master, in order to rebuild a new network with the remaining Slaves (see procedure below). In this way the new network is up and running (without a Slave) while the disconnected Slave (it must be reset if the battery is removed) can be used in other networks.

To start the abovementioned procedure one can envisage e.g. to press a button, a sequence of key presses or navigating a particular menu.

If the Master is to be replaced, the invention solves the problem as follows. See FIG. 2:
a Slave belonging to the old network and the new Master node are taken;
by using e.g. a predefined sequence of key presses of the new Master and of the old Slave a transfer function of code (block A) is activated. In practice, the Slave transmits to the new Master the network address, which is also the identification code of the failed Master. The procedure for replacing a faulty Master starts with the new Master listening, for example by radio, to receive from a Slave the network address of the failed Master (block A). The waiting in reception of the new Master is controlled by a timer (block B) or countdown, elapsed which the procedure ends (block C). This has the advantage of shortening the deadtime and avoiding infinite loops of waiting.

With this code/address the new Master orders a reset of the network by sending a specific command to each Slave (block D), i.e. the internal memory of the Slave is cleared. The passage of code (address) into the new Master allows it to order to reset only to Slaves included in the network of the failed Master, and to become the successor Master for that very network through a new initialization/configuration. On the other hand, the Slaves acknowledged, before the failure, as their Master that which was sending the same code/address, and will do the same after the reconfiguration of the network, avoiding in the reset phase to execute commands from other Masters.

During the reset for substitution of Slave, the Master sends a reset signal until all the Slaves confirm the reset.

Note that the Master would not know how many Slaves are to be rejoined, and if a Slave would be missing in the reconfigured network the Master could not detect it. This problem is solved either by special signaling means which signal to the user the state installed or not of a Slave (light signals), or, as above, initializing the network from scratch, or by including in the data stored by each Slave also the number of Slaves belonging to the network and sending it to the Master together with the network address. This number is known by the Master and is transmitted to each Slave, which stores it.

After the reset of all the Slaves, the new Master must reconfigure/re-initialize a new network.

Note that in this type of applications one can not expect from an end user or the installer (generally electricians) self-possessed skills of radio technology, thus the realization of the network must take place easily and reliably, that is to say that the setup process should be invisible to the user and occur in a simple and automatic manner.

The process of (re)initialization/(re)configuration of the network according the invention, from block E on, is very simple, intuitive and requires no experience or special knowledge from the installer. Moreover, an inexperienced user is able to diagnose and fix any malfunction simply.

It is possible to activate and perform the initialization procedure after the mechanical fixing in situ of all components belonging to the network, but it is also possible to take the reverse path, i.e. to perform the setup procedure in a different place. For example, one can work at home or in factory to create the communication network, and then proceed only to the mechanical fastening of components in situ. The second procedure has the advantage of creating the network in place without obstacles and free from radio interference, a situation of greater convenience and protected from the weather conditions.

A preferred sequence of operations for the network configuration is as follows:
if it is not, the Master is turned on (the Master is powered by inserting a battery, by cable or bus if the Master is wired or integrated into the structure of the gearmotor);
the Master, like every other node in the network, as soon as it is switched on verifies (in its non-volatile memory) if it is not already part of a network. If not, it generates a code/pseudo-random number to form its address. In the Master, the generated code/number, besides being its own address, will also be the address of the network which it will control. To make it unlikely that two Master devices can generate two identical codes every byte that makes up the address can be generated e.g. as follows: performing the XOR operation between the byte (or Word) which represents the Received Signal Strength Indicator (RSSI), and the byte which represents the LSB byte of the battery voltage and the byte which represents the ambient temperature, all recorded and digitally converted by an ADC.

To avoid interference problems in case two Master of two neighboring networks generate the same address, so that a Slave receives messages from two different Masters, the invention provides that whenever the Master node generates an address, it tries to communicate with any adjacent Master using a particular message. The Master verifies with the adjacent ones that its newly generated address is unique, not equal to that of the adjacent Masters. Unless the Master receives an objection the address is stored, otherwise it generates a new one and repeats the verification process with the other Masters;
signalling means present on the Master, for example a LED that flashes, indicate that no Slave is still part of its network,
at this point (block F), automatically and/or through e.g. the push of a button by a user, the Master enters the Slave acquisition mode, that is it stays listening for the connection request from a Slave;
by inserting the battery in a Slave, or, if it is already inserted, with the push of a button, the Slave is commanded to emit by radio (block G) the connection request and its own identification code, which will be received and stored by the Master. To acknowledge, the Master can signal that the connection has taken place through warning means, e.g. a sound by a buzzer;
the Master will send to the Slave just connected a signal of proper connection, to which e.g. the Slave can answer signaling by warning means the condition of joining to the network NT1, e.g. by turning some LEDs on; then the procedure for the Slave is closed;
the procedure is repeated for all the Slave to be installed;
the acquisition procedure is terminated (block I) e.g. by pressing a button on the Master (block H) or after the expiration of a preset timing (block K).

The nodes of the network exchange functional parameters (block L) e.g. the network address, the command to be executed, their own identification code, the code of the transmission channel, the code/data that describes the status of the Slave, and preferably go into low-power mode (block MC).

At this point the network is installed/configured and ready to work.

The Master-Slave topology of the network is an advantageous form because it simplifies control, but the invention also applies to a different network, e.g. a Token-ring topology.

Each component according to the invention can comprise a memory wherein the total number of network components is stored.

1. Substitution/addition method of components in a home automation wireless system (NT1), for example for sliding or hinged doors or garage doors, shutters, blinds, curtains or blinds in general,
the system being equipped with a Master component (M 1) and at least one Slave component (SI) that are configured as a network (NT1) using the Master/Slave technique and communicate according to a wireless communication protocol in which
the at least one Slave and/or Master component stores an identifier data that is used in the protocol as identifier of the Master component and/or of the network (NT1), and
the at least one Slave component transmits said identifier data to a component not belonging to the network so that the latter can receive and store it.

2. Method according to claim 1, wherein the presence of a power-supply battery of a Master and/or Slave component is detected and the transfer of said identifier data of the component is made on the basis of the detection.

3. Method according to claim 1, wherein said data identifies or is the address of the network with which the Master and Slave components of the system discriminate their belonging to the network (NT1).

4. Method according to claim 1, wherein the data is a component-identifying data with which the component is recognized and addressed in the network.

5. Method according to claim 4, wherein the component not belonging to the network is a new Master component to be installed that sends a reset command upon receipt and storage of said data, the command comprising the stored identifier data or the network address, so that the command is received and executed only by members of the network (NT1).

6. Method according to claim 1, wherein—the total number of components in the network is stored within a component already installed;
the number is transmitted by the Master and/or Slave component already installed to a Master and/or Slave component to be installed.

7. Method according to claim 1, wherein the Master component verifies that there are other components that use the same data in adjacent networks.

8. Component or Master and/or Slave node (M 1, SI) of a home automation wireless network (NT1), for example, to operate or control sliding gates or swing gates, comprising
a memory for storing an identifier data that is used in the wireless transmission protocol for identifying the Master component and/or the network (NT1), the data being either an identifying data or the address of the network with which the Master and Slave components discriminate their belonging to the network or a component-identifying data with which the component is recognized and addressed in the network;
a wireless transmitter and/or receiver;
a microprocessor programmed to transmit said data to a component to be installed and/or to receive the data to store it.

9. Component according to claim 8, comprising means interfaced with the microprocessor for detecting the presence of a power supply battery, wherein the microprocessor is programmed to operate the transfer of the data according to the detection.

10. Component according to claim 8, wherein the microprocessor is programmed to send a reset command together with the identifier data or network address, so that the command is received and executed only by components of the network.

11. Method according to claim 2, wherein said data identifies or is the address of the network with which the Master and Slave components of the system discriminate their belonging to the network (NT1).

12. Method according to claim 2, wherein the data is a component-identifying data with which the component is recognized and addressed in the network.

13. Method according to claim 3, wherein the data is a component-identifying data with which the component is recognized and addressed in the network.

14. Method according to claim 2, wherein—the total number of components in the network is stored within a component already installed;
the number is transmitted by the Master and/or Slave component already installed to a Master and/or Slave component to be installed.

15. Method according to claim 3, wherein—the total number of components in the network is stored within a component already installed;
the number is transmitted by the Master and/or Slave component already installed to a Master and/or Slave component to be installed.

16. Method according to claim 4, wherein—the total number of components in the network is stored within a component already installed;
the number is transmitted by the Master and/or Slave component already installed to a Master and/or Slave component to be installed.

17. Method according to claim 5, wherein—the total number of components in the network is stored within a component already installed;
the number is transmitted by the Master and/or Slave component already installed to a Master and/or Slave component to be installed.

18. Method according to claim 2, wherein the Master component verifies that there are other components that use the same data in adjacent networks.

19. Method according to claim 3, wherein the Master component verifies that there are other components that use the same data in adjacent networks.

20. Method according to claim 4, wherein the Master component verifies that there are other components that use the same data in adjacent networks.
